(19) United States
(12) Patent Application Publication
(10) Pub. No.: US 2020/0189397 A1
(43) Pub. Date: Jun. 18, 2020

(54) WIND-POWERED ELECTRIC VEHICLE POWER REGENERATION SYSTEM

(71) Applicant: Xavier Mangum, Jackson, MS (US)

(72) Inventor: Xavier Mangum, Jackson, MS (US)

(21) Appl. No.: 16/714,222

(22) Filed: Dec. 13, 2019

Related U.S. Application Data
(60) Provisional application No. 62/779,431, filed on Dec. 13, 2018.

(51) Int. Cl. B60L 8/00; B60K 16/00; H02J 7/14; H02J 7/34; B60H 1/28

(52) U.S. Cl. CPC B60L 8/006; B60K 16/00; B60H 1/28; H02J 7/345; H02J 7/342; H02J 7/14

(57) ABSTRACT

A wind-powered electric vehicle power regeneration system for increasing the range of electric vehicles. The system includes a twin turbine system with at least one fan on each turbine, and may include a vacuum-assisted turbine and gearbox. The twin turbine system preferably has three fans on each turbine. The fans may be of various sizes. The first and largest fan may be directly powered via the electric vehicle motor, which may create a vacuum. The second fan may partially be powered by the EV motor, while also being moved by the vacuums suction and the air that enters the compartment. The third fan may rotate via force of air entering the compartment. All of the fans may be connected to a central gearbox located beneath them. The gearbox may be connected to a generator that may be connected to a capacitor that charges an electric vehicle's battery.

### CROSS-REFERENCE TO RELATED APPLICATION

The present application is related to and claims priority from prior provisional application Ser. No. 62/779,431, filed Dec. 13, 2018 which application is incorporated herein by reference.

### BACKGROUND OF THE INVENTION

### 1. Field of the Invention

The present invention relates generally to the field of power regeneration systems and more specifically relates to a low-powered vacuum-assisted turbine and gearbox that generates electricity from wind channeled through special vents.

### 2. Description of the Related Art

Transform wind resistance into power and add more mileage between charges with an Electric Vehicle (“EV”) Turbine. The currently available regeneration systems include large modules that sit on the top of the vehicle, such as that shown in U.S. Pat. No. 10,018,176 to Kiselovs, adding wind resistance and drag to the car, thereby increasing energy consumption while seeking to recharge the battery. When every bit of energy matters, wind resistance can be a big drag on the range and speed of electric vehicles. Therefore a need exists for a way for drivers to capture the headwinds caused by passing traffic or weather patterns and use them to power their vehicles and improve their vehicles range and capability.

Various attempts have been made to solve problems found in power regeneration systems art. Among these are found in: U.S. Pat. No. 5,917,304 to Curtis D. Bird; U.S. Pub. No. 2006/0272863 to Brad Donahue; U.S. Pat. No. 3,878,913 to Lionts et al; U.S. Pub. No. 2013/0314023 to Michael Orlando Collier; U.S. Pat. No. 9,306,399 to Kim et al; and U.S. Pat. No. 10,018,176 to Kiselovs. This prior art is representative of electric vehicle power regeneration systems.

None of the above inventions and patents, taken either singly or in combination, is seen to describe the invention as claimed. Thus, a need exists for a reliable wind-powered electric vehicle power regeneration system with low-powered vacuum-assisted turbines and a gearbox that generates electricity from wind channeled through special vents and to avoid the above-mentioned problems.

### BRIEF SUMMARY OF THE INVENTION

In view of the foregoing disadvantages inherent in the known power regeneration systems art, the present invention provides a novel wind-powered electric vehicle power regeneration system. The general purpose of the present invention, which will be described subsequently in greater detail, is to provide a vacuum assisted turbine and gearbox for increasing the range of electric vehicles.

The wind-powered electric vehicle power regeneration system includes a specially designed low-powered vacuum-assisted turbine and gearbox that generates electricity from wind channeled through special vents. Louvered ducts incorporated into the front apron of the electric car are controlled by an air velocity sensor, which detects when there is a net gain of headwind working against the vehicle during driving. The excess wind is then collected by the front and side vents, sending air over twin turbines to generate electricity. This will reduce power loss and extend the vehicle's battery life and drive time.

The twin turbine system preferably provides three fans of various sizes; the largest fan may be powered by air flow, or directly powered via the electric vehicle motor, creating a vacuum. The second fan is preferably partially powered by the electric vehicle motor, while also being turned by the vacuum suction created by the first fan and the air that enters the compartment. The third fan preferably rotates entirely via force of air entering the fan compartment. The motion of the first and second fan being turned by the air is transferred through a gearbox and converted into electricity through a generator. All of the fans may be connected to a central gearbox located beneath them. The gearbox may be connected to a generator that may in turn be connected to a capacitor that charges the electric vehicle's battery.

Easy to use and packed with features and benefits:

Increases range of electric vehicles

Multiple built-in exit air vents improves aerodynamics and reduces drag

Front louvered grill opens to allow air flow into manifold and across turbines

Air velocity meter is located within lower vent on front end of vehicle

Turbine shaft is geared to generator and generator sends power to batteries

Recover wasted energy lost to wind resistance when driving into head winds

The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures that accompany the written portion of this specification illustrate embodiments and method(s) of use for the present invention, wind-powered electric vehicle battery charger, constructed and operative according to the teachings of the present invention.

FIG. 1 shows a side view illustrating an electric vehicle with the adjustable grill covering the opening to the chamber housing the wind-powered electric vehicle power regeneration system, according to an embodiment of the present invention.

FIG. 2 shows a front view illustrating an electric vehicle with the adjustable grill covering the opening to the chamber housing the wind-powered electric vehicle power regeneration system in an open position, according to an embodiment of the present invention.

FIG. 3 shows a front view illustrating an electric vehicle with the adjustable grill covering the opening to the chamber housing the wind-powered electric vehicle power regeneration system in a closed position, according to an embodiment of the present invention.

FIG. 4 shows a perspective view illustrating the airflow through the grill, the chamber housing the wind-powered electric vehicle power regeneration system, the power regeneration system, and out of the vehicle, according to an embodiment of the present invention.

FIG. 5 shows a side view illustrating the airflow along the side of the vehicle and out the back grills after traveling through the wind-powered electric vehicle power regeneration system, according to an embodiment of the present invention.

FIG. 6 shows a top view illustrating the airflow out of the front windshield grills and along the front windshield of the vehicle after traveling through the wind-powered electric vehicle power regeneration system, according to an embodiment of the present invention.

FIG. 7 shows a front view of the wind-powered electric vehicle power regeneration system, according to an embodiment of the present invention.

FIG. 8 shows a perspective view of the wind-powered electric vehicle power regeneration system, according to an embodiment of the present invention.

The various embodiments of the present invention will hereinafter be described in conjunction with the appended drawings.

### DETAILED DESCRIPTION

As discussed above, embodiments of the present invention relate to a power regeneration system and more particularly to a wind-powered electric vehicle power regeneration system.

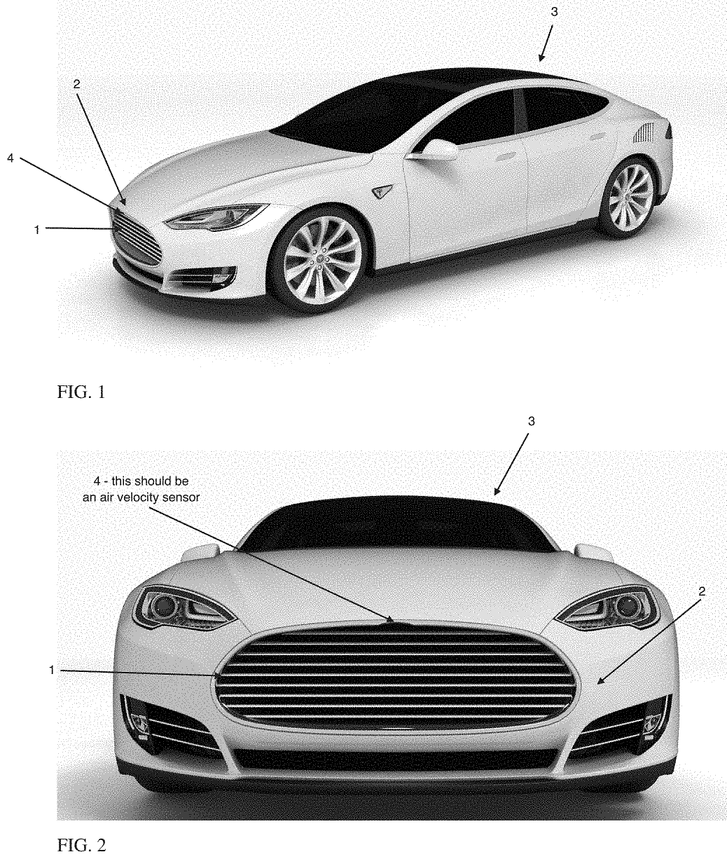

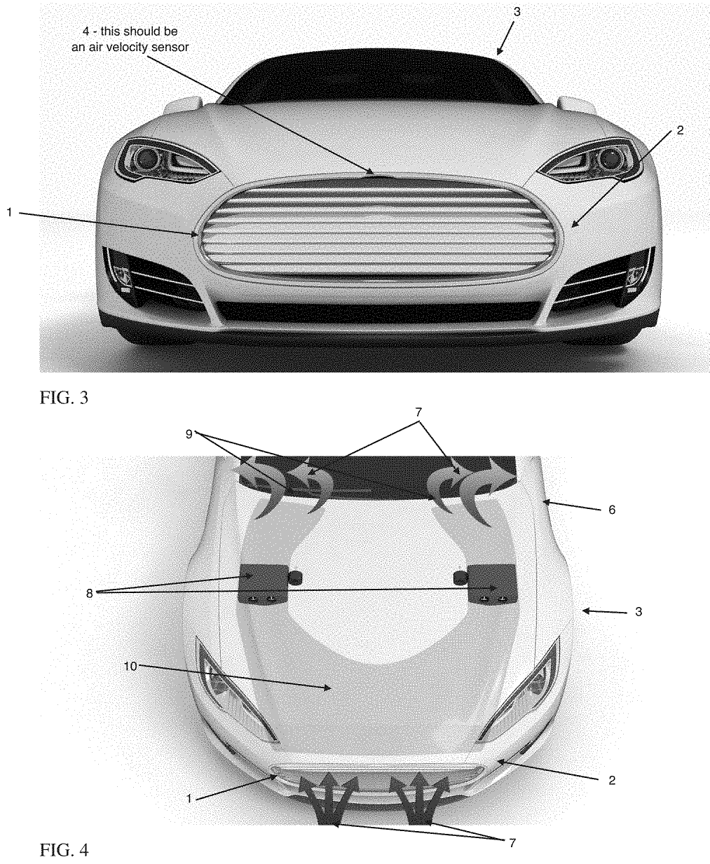

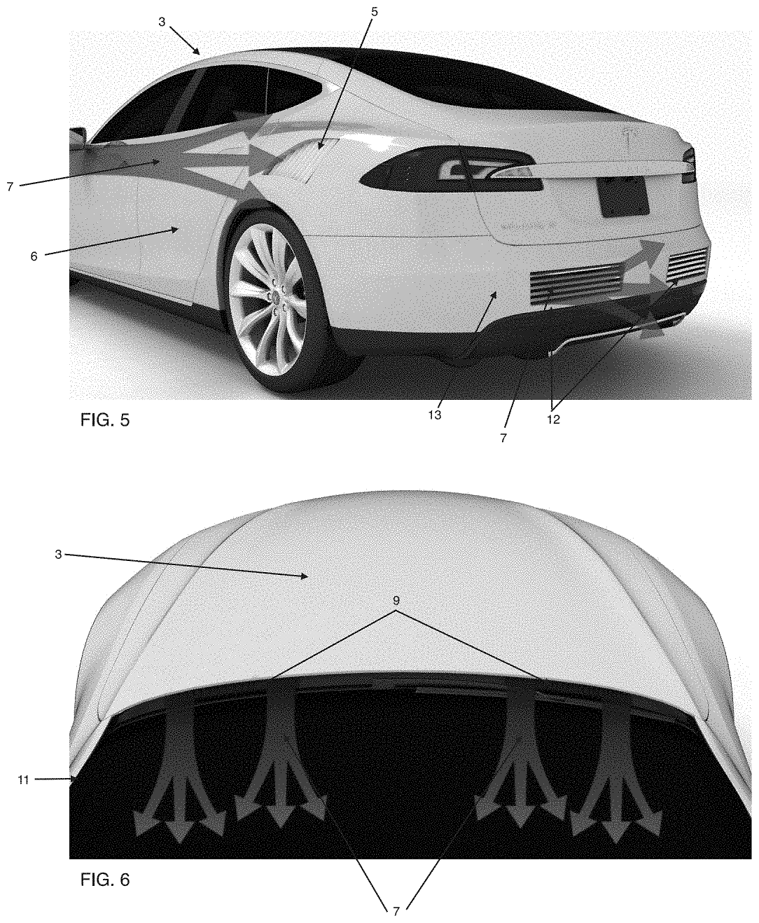

Referring now to the drawings FIGS. 1-8, the wind-powered electric vehicle power regeneration system includes a specially designed low-powered vacuum-assisted turbine and gearbox that generates electricity from wind channeled through special vents. As shown in FIGS. 1-3 and 7, louvered ducts 1 incorporated into the front apron 2 of the electric car 3, and louvered ducts 5 located at the back of the left and right sides 6 of the car, are controlled by an air velocity sensor 4. The air velocity sensor 4 detects when there is a net gain of headwind working against the vehicle 3 while a user is driving.

As shown in FIGS. 4-6, the excess wind is collected by the front vent 1, sending air 7 through an air chamber 10 within the car's 3 hood and over one or more twin turbines systems 8 to generate electricity. The air 7 exits through the windshield vents 9, and slides up over the windshield 11 with the air that didn't go through the front vent 1 to reduce drag. The excess wind that goes around the car 3 is collected by the side vent 5 on each side of the car 6 and sent over one ore more twin turbines system 8 to generate electricity. The air 7 exits through the rear vents 12 in the back bumper 13 of the vehicle 3. This will reduce power loss and extend the vehicle's battery life and drive time.

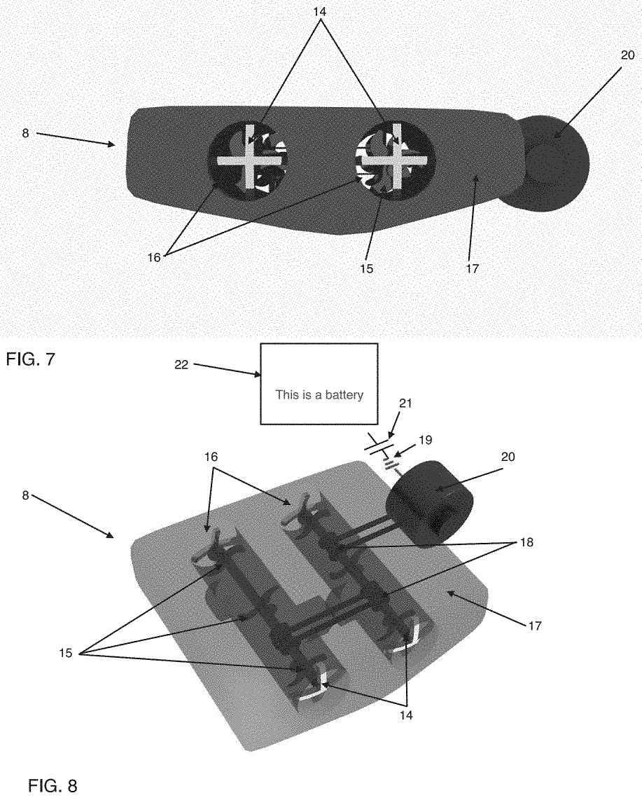

As shown in FIGS. 7-8, the twin turbines system 8 has two turbines 14, each of which preferably has three fans 15. The turbines 14 are each housed in a channel 16 in the body 17 of the twin turbines system 8. The fans 15 may be various sizes. The largest fan may be powered by air flow, or directly powered via the electric vehicle motor, creating a vacuum. The second fan is preferably partially powered by the electric vehicle motor, while also being turned by the vacuum suction created by the first fan and the air that enters the compartment. The third fan preferably rotates entirely via force of air entering the fan compartment. The motion of the fans 15 being turned by the air 7 is transferred through a gearbox 18 and converted into electricity 19 through a generator 20. All of the fans 15 may be connected to a central gearbox 18. The gearbox 18 may be connected to a generator 20 that may in turn be connected to a capacitor 21 that charges 19 the electric vehicle's battery 22.

The wind-powered electric vehicle power regeneration system is cost-effective to produce in the embodiments, as shown in FIGS. 1-8.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claim:

1. A wind-powered electric vehicle power regeneration system comprising:
(a) a moveable, louvered front duct with a plethora of slats operably incorporated into a front apron of an electric vehicle
(b) at least one windshield vent operably positioned to vent air at a base edge of a front windshield of the electric vehicle;
(c) a first wind chamber operably connected to the front duct and the at least one windshield vent so that air flows in the front duct and out the at least one windshield vent;
(d) an air velocity sensor position on the front apron of the electric vehicle,
wherein the air velocity sensor is operably connected to control the front duct so as to move the plethora of slats of the front duct into an open position when the air velocity sensor detects a net headwind against the front apron of the electric vehicle, and to move the plethora of slats of the front duct into a closed position when the air velocity sensor does not detect a net headwind against the front apron of the electric vehicle; and
(e) at least one front twin turbine system having
(i) a main body;
(ii) a first tube and a second tube, wherein the first tube and the second tube are located within the main body, and wherein each tube is open at a front end and a back end;
(iii) a first turbine and a second turbine, wherein each turbine has at least one fan thereon, wherein the first turbine is housed within the first tube, and wherein the second turbine is housed within the second tube;
(iv) at least one gearbox operably connected to the first turbine and the second turbine;
(v) a generator operably connected to the gearbox; and
(vi) a capacitor operably connected to the generator to charge a battery powering the electric vehicle,
wherein the at least one twin turbine system is operably positioned within the first wind chamber so that the air flowing through the wind chamber causes at least one fan of the first turbine and at least one fan of the second turbine to rotate.

2. The wind-powered electric vehicle power regeneration system according to claim 1, wherein there are two windshield vents.

3. The wind-powered electric vehicle power regeneration system according to claim 1, wherein there are two twin turbine systems.

4. The wind-powered electric vehicle power regeneration system according to claim 1, wherein there are three fans on the first turbine and three fans on the second turbine.

5. The wind-powered electric vehicle power regeneration system according to claim 4, wherein one of the three fans on the first turbine and one of the three fans on the second turbine are rotated in part or entirely by the battery of the electric vehicle and create a vacuum, and wherein the vacuum assists at least one of the other two fans on the first turbine and at least one of the other two fans on the second turbine to rotate.

6. The wind-powered electric vehicle power regeneration system according to claim 1, further comprising:
(f) a moveable, louvered left side duct with a plethora of slats on a left side of the electric vehicle;
(g) a moveable, louvered right side duct with a plethora of slats on a right side of the electric vehicle,
wherein the air velocity sensor is also operably connected to control the left side duct and the right side duct so as to move the plethora of slats of the left side duct and the plethora of slats of the right side duct into an open position when the air velocity sensor detects a net headwind against the front apron of the electric vehicle, and to move the plethora of slats of the left side duct and the plethora of slats of the right side duct into a closed position when the air velocity sensor does not detect a net headwind against the front apron of the electric vehicle;
(h) a left bumper vent and a right bumper vent;
(i) a left side wind chamber operably connected to the left side duct and the left bumper vent so that air flows in the left side duct and out the at left bumper vent;
(j) a right side wind chamber operably connected to the right side duct and the right bumper vent so that air flows in the right side duct and out the at right bumper vent;
(k) a left side twin turbine system operably positioned within the left side wind chamber so that the air flowing through the wind chamber causes at least one fan of the first turbine and at least one fan of the second turbine to rotate; and
(l) a right side twin turbine system operably positioned within the right side wind chamber so that the air flowing through the wind chamber causes at least one fan of the first turbine and at least one fan of the second turbine to rotate.

7. The wind-powered electric vehicle power regeneration system according to claim 6, wherein there are two windshield vents.

8. The wind-powered electric vehicle power regeneration system according to claim 6, wherein there are two front twin turbine systems.

9. The wind-powered electric vehicle power regeneration system according to claim 6, wherein there are three fans on the first turbine and three fans on the second turbine or each twin turbine system.

10. The wind-powered electric vehicle power regeneration system according to claim 9, wherein one of the three fans on the first turbine and one of the three fans on the second turbine are rotated in part or entirely by the battery of the electric vehicle and create a vacuum, and wherein the vacuum assists at least one of the other two fans on the first turbine and at least one of the other two fans on the second turbine to rotate.
